(19) United States
(12) Patent Application Publication
(10) Pub. No.: US 2025/0170936 A1
(43) Pub. Date: May 29, 2025

(54) SEAT ARMREST MODULE WITH INTEGRATED HEADREST

(71) Applicant: Tesla, Inc., Austin, TX (US)

(72) Inventors: Ojas Tayal, Mountain View, CA (US); David Banales, Oakland, CA (US)

(21) Appl. No.: 18/963,871

(22) Filed: Nov. 29, 2024

Related U.S. Application Data
(60) Provisional application No. 63/603,436, filed on Nov. 28, 2023.

(51) Int. Cl. B60N 2/75; B60N 2/20; B60N 2/818; B60N 2/838; B60N 3/10

(52) U.S. Cl. CPC B60N 2/757; B60N 2/206; B60N 2/818; B60N 2/838; B60N 3/102

(57) ABSTRACT

A seat assembly for an automotive vehicle, the middle seat assembly including a middle frame, a fixed portion, and a movable portion. The middle frame can be securable to a frame of a seat assembly between a first seat and a second seat of the seat assembly. The fixed portion can be connected to the middle frame. The movable portion can include a headrest. The movable portion can be pivotably connected to the middle frame and can be movable between an upright position where the movable portion forms a backrest of a middle seat of the seat assembly and between a lowered position where the movable portion forms an armrest between the first seat and the second seat.

### CLAIM OF PRIORITY

This patent application claims the benefit of priority, under 35 U.S.C. Section 119(e), to Ojas, Tayal, U.S. Patent Application Ser. No. 63/603,436, entitled “SEAT ARMREST MODULE WITH AN INTEGRATED AND DEPLOYABLE HEADREST,” filed on Nov. 28, 2023, which is hereby incorporated by reference herein in its entirety.

### BACKGROUND

In the automotive industry, the evolution of automotive seating has been driven by an increasing emphasis on enhancing user comfort, providing customizable support, and ensuring the safety of vehicle occupants. As a significant aspect of a vehicle's interior ergonomics, the seat must seek to accommodate a wide range of body types, preferences, and seating positions.

Traditional vehicle seats are engineered with a multitude of adjustment mechanisms to cater to these diverse requirements. These mechanisms typically involve a series of levers, sliders, and linkages, each designed to control a specific aspect of the seat's position. The complexity of these systems arises from the need to balance multiple factors, such as the ease of adjustment, the durability of moving parts, and the precision required to maintain the seat's position under dynamic conditions.

The design of seat adjustment systems is often further complicated by the need to integrate these mechanisms into the limited space of a vehicle's cabin while maintaining a sleek and unobtrusive appearance. The components must typically be compact yet strong, capable of withstanding the forces exerted during regular adjustments, as well as the stresses encountered during vehicle operation, including acceleration, deceleration, and impact.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments or examples discussed in the present document.

FIG. 1 illustrates an isometric view of an automotive vehicle, according to some examples.

FIG. 2 illustrates an isometric view of a seat assembly, according to some examples.

FIG. 3 illustrates an isometric view of a seat assembly, according to some examples.

FIG. 4 illustrates an isometric view of a portion of a seat assembly, according to some examples.

FIG. 5 illustrates an isometric view of a portion of a seat assembly, according to some examples.

FIG. 6 illustrates an isometric view of a portion of a seat assembly, according to some examples.

FIG. 7 illustrates an isometric view of a portion of a seat assembly, according to some examples.

FIG. 8 illustrates an isometric view of a portion of a seat assembly, according to some examples.

FIG. 9 illustrates an isometric view of a portion of a seat assembly, according to some examples.

FIG. 10 illustrates an isometric view of a portion of a seat assembly, according to some examples.

FIG. 11 illustrates an isometric view of a portion of a seat assembly, according to some examples.

FIG. 12 illustrates a cross-sectional view of a portion of a seat assembly, according to some examples.

FIG. 13 illustrates a perspective view of an example seat armrest module, according to some examples.

FIG. 14 illustrates a perspective view of an example seat armrest module with the armrest in a deployed position, according to some examples.

FIG. 15 illustrates a perspective view of an example seat armrest module with the headrest in an extended position, according to some examples.

FIG. 16 illustrates an exploded view of portions of the module illustrated in FIGS. 1-3 providing some additional details of the components included therein, according to some examples.

FIGS. 17-23 illustrate additional views of the example seat armrest module illustrated in FIGS. 13-16, according to some examples.

FIG. 24 illustrates a perspective view of an example seat armrest module used with a seat interface frame, according to some examples.

FIG. 25 illustrates a perspective view of an example seat armrest module used with a seat interface frame with the armrest in a deployed position, according to some examples.

FIG. 26 illustrates a perspective view of an example seat armrest module used with a seat interface frame with the headrest in an extended position, according to some examples.

FIG. 27 illustrates a view of a storage space and cargo net, according to some examples.

FIGS. 28 and 29 illustrate additional views of the example seat interface frame, according to some examples.

FIGS. 30 to 32 illustrate the example seat armrest module and seat interface frame installed between two outboard seats, according to some examples.

FIG. 33 illustrates an isometric view of a portion of a seat assembly, according to some examples.

FIG. 34 illustrates an isometric view of a portion of a seat assembly, according to some examples.

FIG. 35 illustrates an isometric view of a portion of a seat assembly, according to some examples.

FIG. 36 illustrates an isometric view of a portion of a seat assembly, according to some examples.

FIG. 37 illustrates an isometric view of a portion of a seat assembly, according to some examples.

### DETAILED DESCRIPTION

Seat assemblies are commonly used in automotive vehicles and especially in consumer vehicles. Typical rear seat assemblies often include an assembly including multiple seats, often arranged as a bench with one or more common seats and one or more common back rests. Some rear seat assemblies can include a middle seat with an integral backrest that moves or rotates to form an armrest. However, such moving armrests tend to be relatively small and may be difficult to move out of backrest position and into the armrest position.

This disclosure helps to address these issues (among others) by providing a seat assembly including a movable portion that includes the back support and headrest to form a relatively large armrest when moved to the armrest position. By making the headrest integral to the backrest or arm rest, the size of the armrest can be increased considerably. The armrest or movable portion of the seat assembly can also include a locking mechanism and release mechanism that can be easily operated to allow the seat to be easily moved between the stored position to the downward position.

The above discussion is intended to provide an overview of subject matter of the present patent application. It is not intended to provide an exclusive or exhaustive explanation of the inventive subject matter. The description below is included to provide further information about the present patent application.

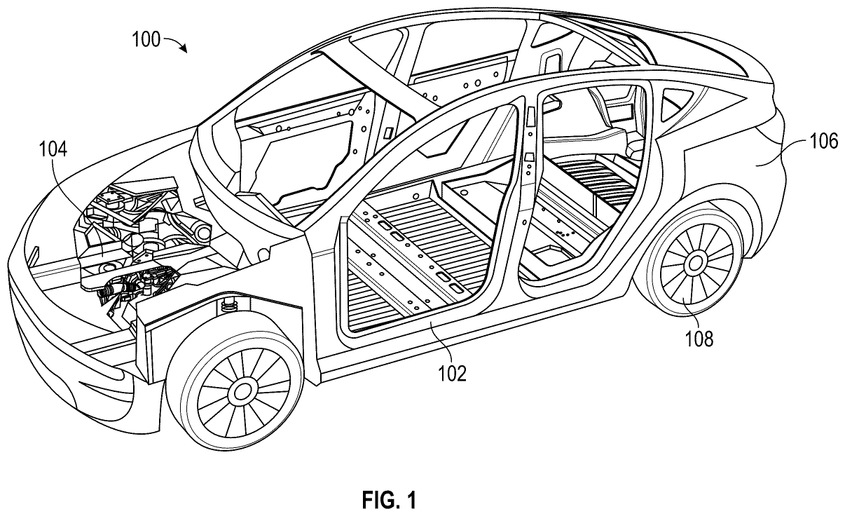

FIG. 1 illustrates an isometric view of an automotive vehicle 100, according to some examples. The automotive vehicle 100 can be a car, vehicle, automobile, or the like, operable to transport occupants or items over a road or other terrain. The automotive vehicle 100 can include a chassis 102, a drivetrain 104, panels 106, and wheels 108. The wheels 108 can engage with a road or terrain and can be configured to support the automotive vehicle 100. The chassis 102 can support the drivetrain 104, which can be connected to the wheels 108. The drivetrain 104 can be operable to drive the wheels 108 to rotate such as to move the automotive vehicle 100. The panels 106 can be connected to the chassis 102 and can help to reinforce the chassis 102 and improve drag or air resistance during transportation. As discussed in further detail below, the automotive vehicle 100 can also include one or more seats or seat assemblies securable to the chassis 102 and configured to support, and help restrain, occupants within the automotive vehicle 100.

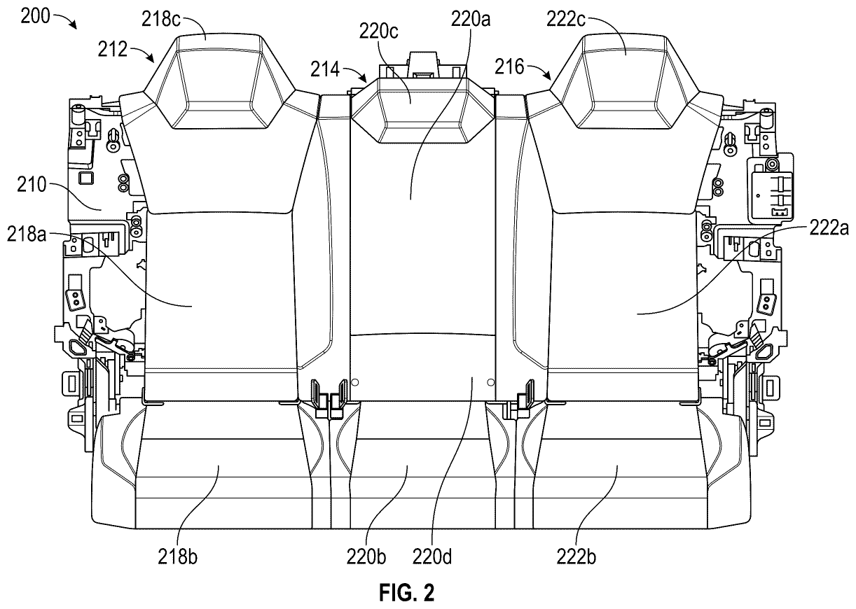

FIG. 2 illustrates an isometric view of a seat assembly 200 or seat module for an automotive vehicle, according to some examples. The seat assembly 200 can include a frame 210, a passenger seat 212, a middle seat assembly 214, and a driver seat 216. Each of the seats 212-216 can be a seat or a seat assembly configured to support a passenger within a vehicle, such as the automotive vehicle 100.

The frame 210 can be a rigid or semi-rigid body made of materials such as one or more of metals, plastics, ceramics, composites, combinations thereof, or the like, such as steel, aluminum, titanium, or alloys thereof. The frame 210 can be connected (e.g., bolted or welded) to the chassis 102 to secure the seat assembly 200 to the automotive vehicle 100. The frame 210 can include various structural members that can connect to the chassis 102 and can connect to the passenger seat 212, the middle seat assembly 214, and the driver seat 216. Each of the seats or seat assemblies 212, 214, and 216 can include a frame member, cushion member(s), and an upholstery layer, as discussed in further detail below.

The passenger seat 212 can include a backrest portion 218a, a seat portion 218b, and a headrest portion 218c. The middle seat assembly 214 can include a backrest portion 220a, a seat portion 220b, and a headrest portion 220c. The middle seat assembly 214 can also include an access panel 220d that can be removable from the backrest portion 220a and the seat portion 220b to expose a portion of the frame 210 as discussed in further detail below. The driver seat 216 can include a backrest portion 222a, a seat portion 222b, and a headrest portion 222c.

As discussed in further detail below, the headrest portion 220c of the middle seat assembly 214 can be connected to the backrest portion 220a to form a movable portion that can rotate or move relative to the passenger seat 212 and the driver seat 216. In the upright position or configuration shown in FIG. 2, the movable portion can form the backrest portion 220a and the headrest portion 220c and in a deployed or lowered position or configuration the movable portion can form an armrest such that the seat assembly 200 can provide a relatively large armrest when the movable portion is in the lowered position or configuration.

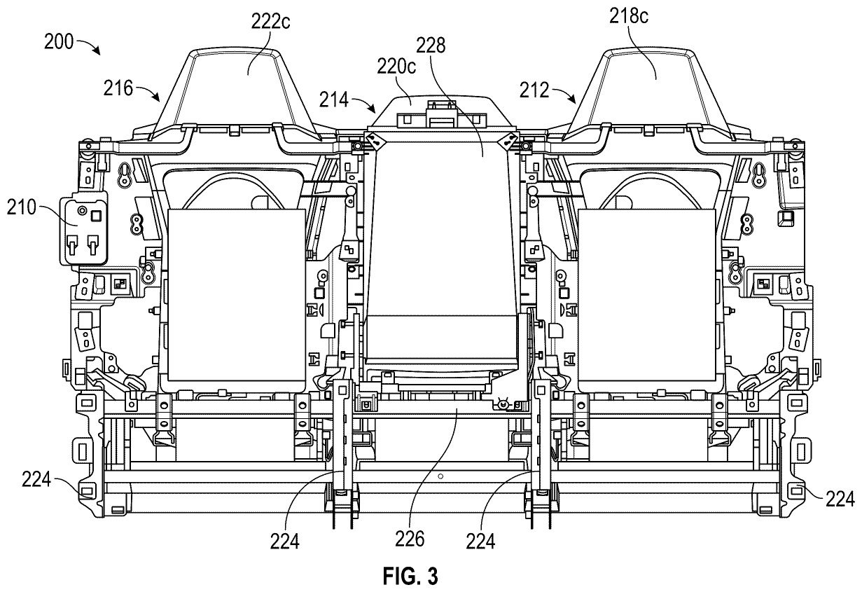

FIG. 3 illustrates a rear isometric view of the seat assembly 200, according to some examples. The seat assembly 200 of FIG. 3 can be consistent with the seat assembly 200 discussed above. FIG. 3 shows additional details of the seat assembly 200.

For example, FIG. 3 shows that the frame 210 can include one or more structural members 224, which can be made of steel, aluminum, one or more metal alloys, or the like, and can be configured to support the seat assembly 200. The one or more structural members 224 can also be connected to the chassis 102 (e.g., through bolts, welds, or the like) to secure the seat assembly 200 to the chassis 102. The frame 210 can also include a cross-member 226 that can be connected to the one or more structural members 224. As discussed below, the middle seat assembly 214 can be secured to the cross-member 226 via one or more fasteners to secure the middle seat assembly 214 to the frame 210 and therefore to the chassis 102.

FIG. 3 also shows that the middle seat assembly 214 can include a backing 228 that can be secured to the frame 210, such as via one or more fasteners. The backing 228 can be made of rigid or semi-rigid materials, such as one or more of metals, polymers, foams, or the like. The backing 228 can remain stationary when the movable portion of the middle seat assembly 214 moves with respect to the frame 210 such that the backing 228 can be exposed when the movable portion of the middle seat assembly 214 is in the lowered position.

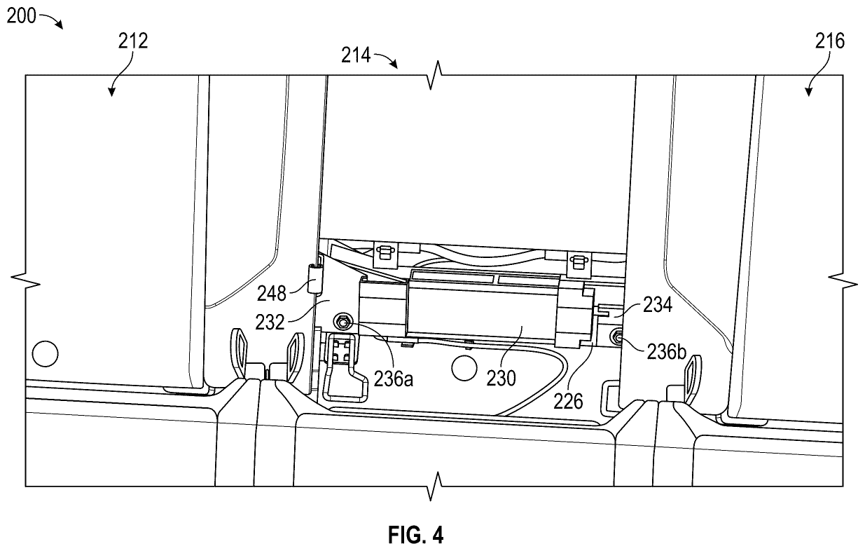

FIG. 4 illustrates an isometric view of a portion of the seat assembly 200, according to some examples. The seat assembly 200 of FIG. 4 can be consistent with the seat assembly 200 discussed above. FIG. 4 shows additional details of the seat assembly 200.

For example, FIG. 4 shows the middle seat assembly 214 with the access panel 220d removed, which can expose a middle frame 230 of the middle seat assembly 214. The middle frame 230 can be (or can be part of) a fixed portion of the middle seat assembly 214 such that the middle frame 230 does not move with respect to the frame 210 when the middle seat assembly 214 is secured to the frame 210. The middle seat assembly 214 can also include a first bracket 232 that can be connected to the middle frame 230 and can include a second bracket 234 that can also be connected to the middle frame 230 on an opposite side of the middle seat assembly 214 from the first bracket 232. Each of the first bracket 232 and the second bracket 234 can be configured to receive a fastener 236 therein or therethrough to secure the middle frame 230 to the frame 210.

For example, the first bracket 232 can receive a fastener 236a at least partially therein or therethrough to secure the first bracket 232 to the frame 210. Similarly, the second bracket 234 can receive a fastener 236b at least partially therein or therethrough to secure the second bracket 234 to the frame 210. In this way, the middle seat assembly 214 can be releasably secured to the frame 210 to secure the middle seat assembly 214 to the seat assembly 200 and to the chassis 102 of the automotive vehicle 100. The middle seat assembly 214 can also be secured to a top portion of the frame 210 by one or more fasteners.

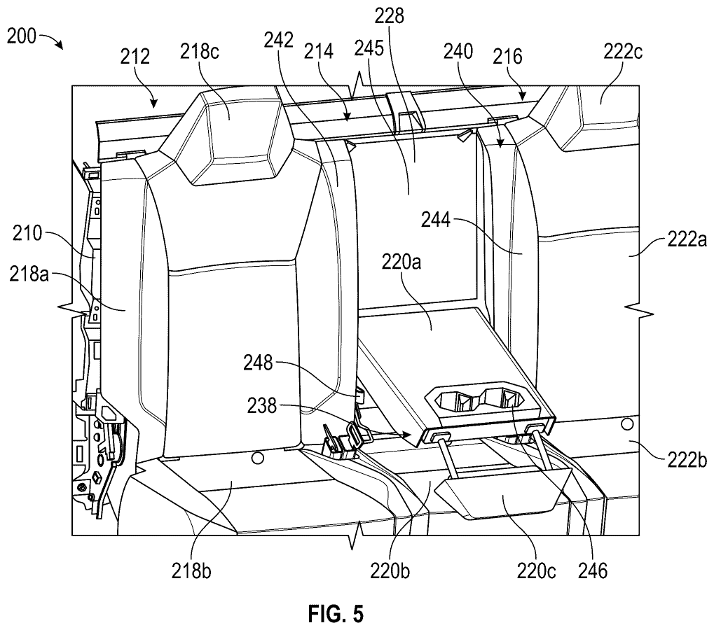

FIG. 5 illustrates an isometric view of a portion of the seat assembly 200, according to some examples. The seat assembly 200 of FIG. 5 can be consistent with the seat assembly 200 discussed above. FIG. 5 shows additional details of the seat assembly 200.

For example, FIG. 5 shows a movable portion 238 (including the backrest portion 220a and the headrest portion 220c of the middle seat assembly 214) in a lowered configuration or position. FIG. 5 also shows that the middle seat assembly 214 can include a fixed portion 240, which can include bolsters 242 and 244 and can include the middle frame 230. The bolsters can be made of foam or other cushion material and can be covered by upholstery (e.g., cloth, leather, or the like). The bolsters 242 and 244 can be secured or fixed to the middle frame 230 such that the fixed portion 240 does not move together with the movable portion 238 between the upright position and the lowered position. In this way, only a portion of the backrest portion 220a can move with respect to the middle seat assembly 214 such that the movable portion 238 is not the entire backrest portion and is therefore properly sized for an armrest. The bolsters 242 and the bolsters 244 can define a recess 245 therebetween configured to receive the backrest portion 220a at least partially therein such that the backrest portion 220a can nest between the bolsters 242 and 244 in the recess 245 when the backrest portion 220a is in the upright or stored position.

The headrest portion 220c can also be part of the movable portion 238 such that the headrest portion 220c can move together with the headrest portion 220c between the upright position and the lowered position. Together, the backrest portion 220a and the headrest portion 220c can together form an armrest when in the lowered position that extends to an end (or near an end) of the seat portion 220b.

The backrest portion 220a can include one or more cupholders 246 integrated into a back portion of the backrest portion 220a such that when the movable portion 238 is moved to the lowered position, the one or more cupholders 246 can support beverage containers or other items at least partially therein. Also, as shown in FIG. 5, the headrest portion 220c can be extended or retracted when in the lowered position, such as for additional storage, as discussed below.

FIG. 5 also shows that the middle seat assembly 214 can include a release 248 (also clearly shown in FIG. 4) connected to a lock and configured to be exposed when the movable portion 238 is in the upright position. The release 248 can be operable to move the lock from the locked configuration to allow the movable portion 238 to be moved from the upright position to the lowered position.

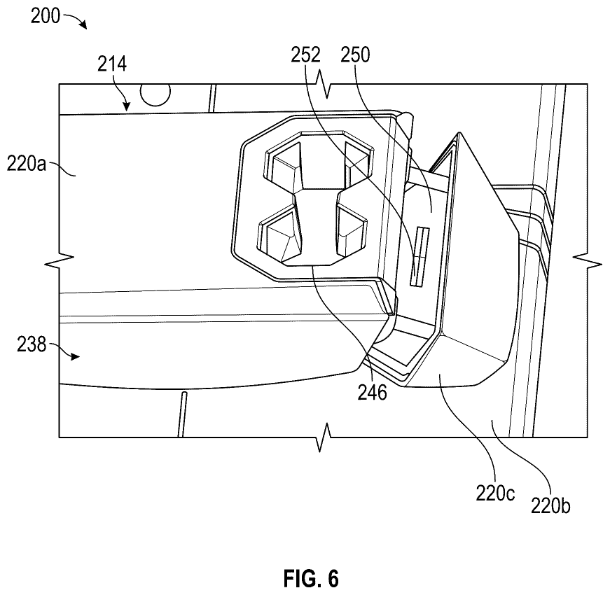

FIG. 6 illustrates an isometric view of a portion of the seat assembly 200, according to some examples. The seat assembly 200 of FIG. 6 can be consistent with the seat assembly 200 discussed above. FIG. 6 shows additional details of the seat assembly 200. For example, FIG. 6 shows that the headrest portion 220c can include a cavity 250 (or compartment) that can be exposed when the headrest portion 220c is moved to the extended position where the cavity 250 can be used to store personal items at least partially therein when the headrest portion 220c is extended and the backrest portion 220a is lowered. The cavity 250 can include one or more ports 252 that can be electrical or communication ports that can be configured to delivered power to a device (e.g., phone or tablet) or can allow for connection to an ECU or other control system of the automotive vehicle 100.

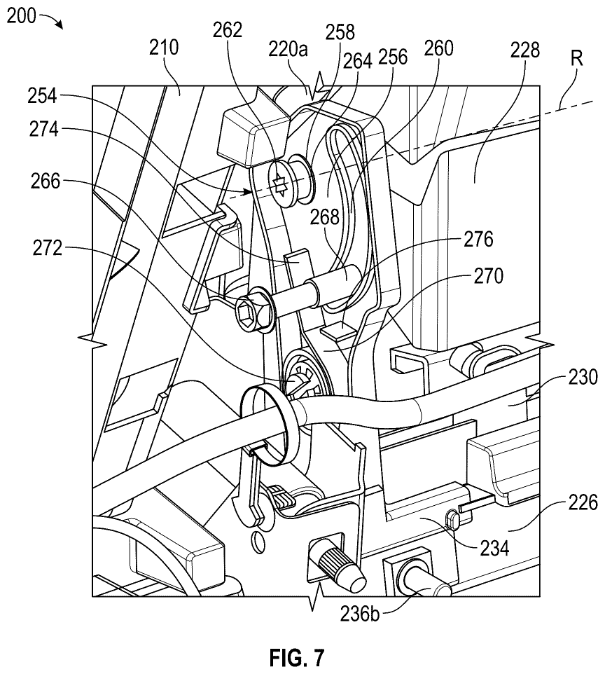

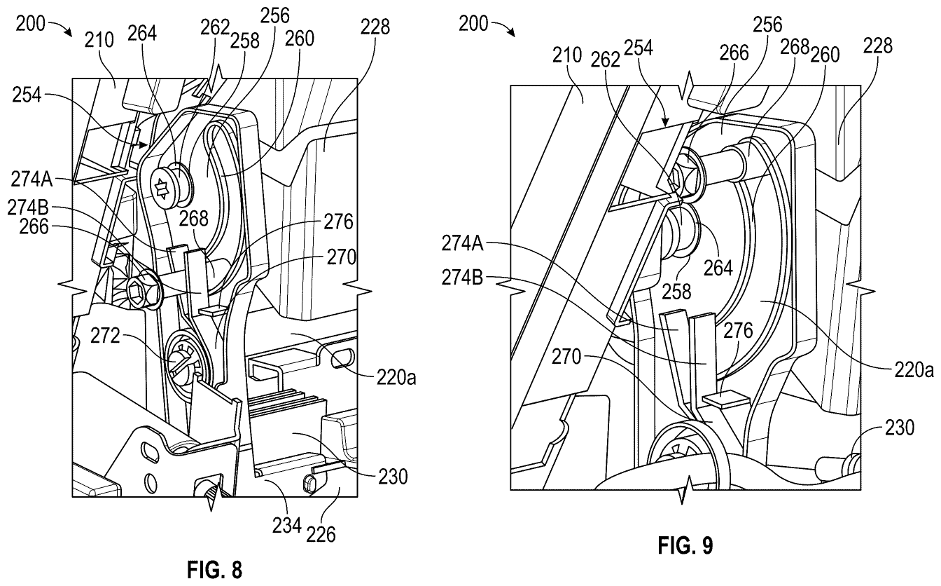

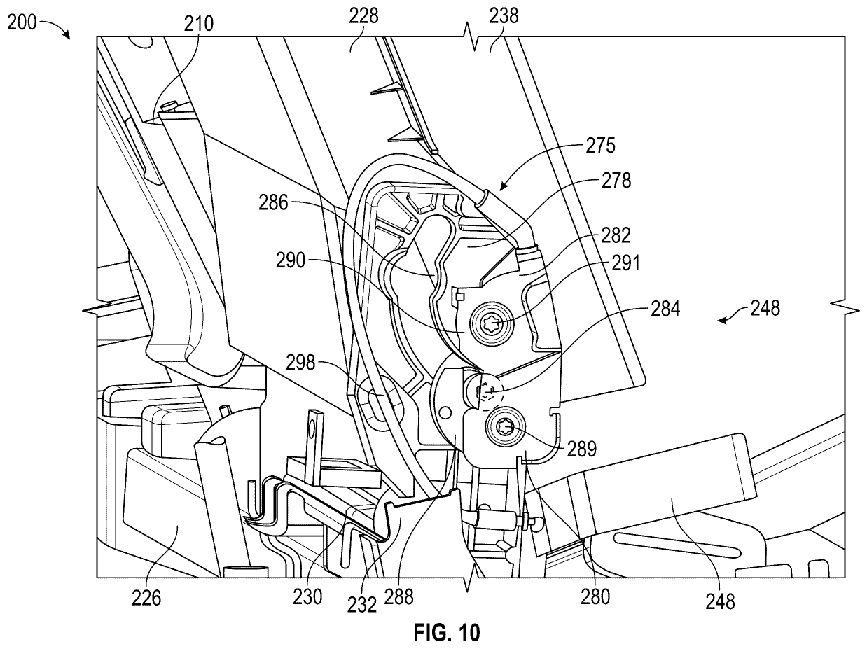

FIG. 7 illustrates an isometric view of a portion of the seat assembly 200, according to some examples. FIG. 8 illustrates an isometric view of a portion of the seat assembly 200, according to some examples. FIG. 9 illustrates an isometric view of a portion of the seat assembly 200, according to some examples.

The seat assembly 200 of FIGS. 7-9 can be consistent with the seat assembly 200 discussed above. FIGS. 7-9 shows additional details of the seat assembly 200. For example, FIG. 7 shows that the seat assembly 200 can include a hinge assembly 254. The hinge assembly 254 can be connected to the movable portion 238 and to the fixed portion 240 such as to allow the movable portion 238 to move with respect to the fixed portion 240.

The hinge assembly 254 can include a body 256, which can be a bracket or the like. The body 256 can be connected to the middle frame 230 or can be integrally formed therewith. The middle frame 230 can also be connected to the cross-member 226 such as via the middle frame 230. The second bracket 234 can also be connected directly to the body 256. In some examples, the second bracket 234 and the body 256 can be integrally formed. The body 256 can define a bore 258 and a slot 260. The bore 258 can be a generally round or circular bore extending at least partially through the body 256. The slot 260 can be an elongate track, guide, or cam profile extending at least partially through the body 256 and configured to at least partially define a range of motion of the movable portion 238.

The hinge assembly 254 can also include a hinge bolt 262 and a bearing 264. The hinge bolt 262 can be a bolt, pin, or other fastener or rigid item configured to extend at least partially through the body 256 and into the middle frame 230 (or other portion of the movable portion 238) to secure the middle frame 230 to the body 256. The bearing 264 can be a bearing such as a Polytetrafluoroethylene (PTFE) bearing configured to at least partially surround a portion of the bore 258 and at least partially define a bearing surface for the hinge bolt 262. The hinge bolt 262 can be configured to allow the movable portion 238 to pivot between the upright position and the lowered position.

The hinge assembly 254 can also include a guide 266, which can be a pin, bolt, fastener, or the like. The guide 266 can extend at least partially through the slot 260 and can be secured to the middle frame 230 (or other portion of the movable portion 238). The guide 266 can include a guide surface 268 which can be a relatively smooth portion of the guide 266 configured to engage an inner surface of the slot 260. The guide surface 268 of the guide 266 can be configured to ride along or within the slot 260 as the movable portion 238 moves between the upright position and the lowered position to at least partially define a path of movement of the movable portion 238 between the upright position and the lowered position.

The hinge assembly 254 can also include a biasing element 270 connected to the body 256. For example, the body 256 can include a boss 272 (shown more clearly in FIG. 8), which can include or can be one or more projections configured to engage the biasing element 270 to secure the biasing element 270 to the body 256. In some examples, the boss 272 can extend through at least a portion of the biasing element 270. The biasing element 270 can be a coiled leaf spring and the boss 272 can extend through a center of a coiled portion (or a connector of the biasing element 270) to secure the biasing element 270 to the body 256. The biasing element 270 can also include an arm 274 (or tab or extension) configured to engage the guide 266 and to bias the guide 266 and the movable portion 238 toward the lowered position.

The hinge assembly 254 can also include a stop 276 connected the body 256. The stop 276 can be a protrusion, projection, extension, or the like extending outward from the body 256. The stop 276 can be configured to engage the biasing element 270 (such as the arm 274 thereof) to limit a range of engagement between the biasing element 270 and the guide 266. FIG. 7 also shows a rotational axis R, which can be defined at least in part by the hinge bolt 262 and the bore 258. The rotational axis R can be an axis of rotation of the movable portion 238 between the upright position and the lowered position.

In operation of some examples, when the movable portion 238 is in the upright position (as shown in FIGS. 7 and 8) and when the release 248 is operated to release the lock, the arm 274 can be in the position 274A (shown in FIGS. 8 and 9) and the arm 274 of the biasing element 270 can engage the guide 266 to move the guide 266 such that the guide surface 268 rides along the slot 260 from the lower position shown in FIGS. 7 and 8 towards the higher position shown in FIG. 9. Such movement of the guide 266 can cause the movable portion 238 to move or rotate about the rotational axis R with respect to the fixed portion 240 from the upright position towards the lowered position, where the path taken by the movable portion 238 between the raised position and the lowered position is guided by the contact between the guide 266 and the guide surface 268.

When the arm 274 engages the stop 276, the biasing element 270 can disengage the guide 266 and gravity (or force from a user) can continue to cause the movable portion 238 to move with respect to the fixed portion 240 towards the lowered position. Movement of the movable portion 238 can continue until the guide 266 reaches an upper end of the slot 260 where contact between the end of the slot 260 and the guide 266 can limit a range of movement of the movable portion 238 such that the movable portion 238 stops in the lowered position, as desired.

When moving the movable portion 238 back to or toward the stored position or configuration, movement of the movable portion 238 can be guided or defined by engagement between the guide 266 and the slot 260. When the guide 266 reaches the arm 274 in the position or configuration of 274B, the guide 266 can apply a force (e.g., applied by the user when closing or moving the movable portion 238 to the closed position) to move the biasing element 270 to the position 270A, causing the biasing element 270 to load as it moves. When the position 274A is reached, the lock assembly can be engaged and the guide 266 and the biasing element 270 can be retained in this configuration (the configuration of FIG. 8). This process can be repeated as desired.

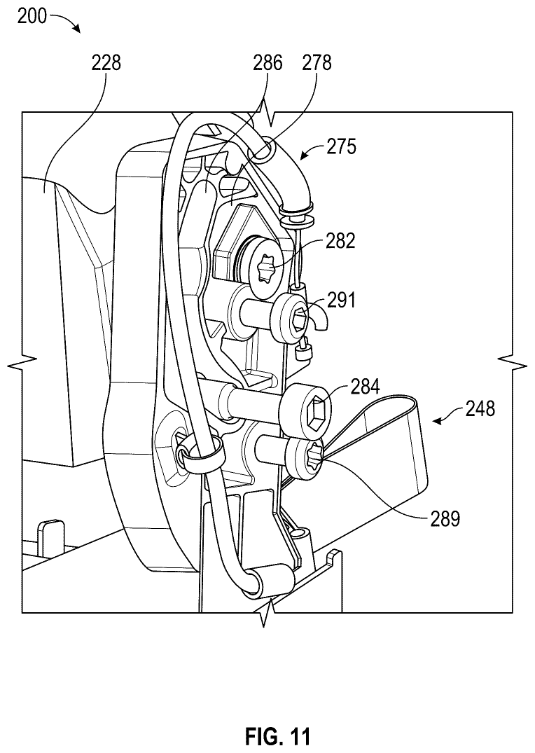

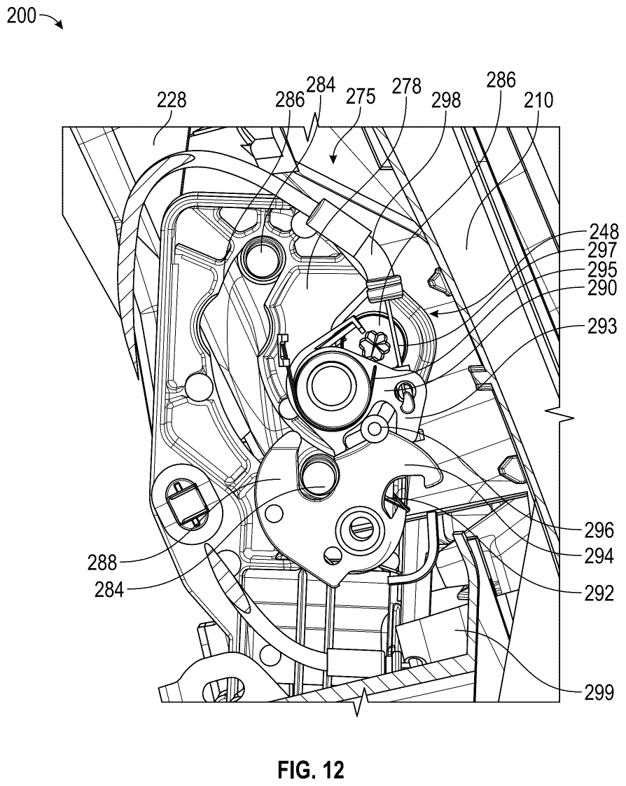

FIG. 10 illustrates an isometric view of a portion of the seat assembly 200, according to some examples. FIG. 11 illustrates an isometric view of a portion of the seat assembly 200, according to some examples. FIG. 12 illustrates a cross-sectional view of a portion of the seat assembly 200, according to some examples. FIGS. 10-12 are discussed together below. The seat assembly 200 of FIGS. 10-12 can be consistent with FIGS. 2-9 above; FIGS. 10-12 show additional details of a lock assembly 275.

Generally, the lock assembly 275 can be connected to the middle frame 230 and can be movable between a locked configuration and an unlocked configuration, where the lock assembly 275 can be configured to retain the movable portion 238 in the upright position when in the locked configuration, and the lock assembly 275 can be configured to release the movable portion 238 when in the unlocked configuration.

As shown in FIG. 10, the lock assembly 275 can include a body or bracket 278 that can be connected to the middle frame 230. The bracket 278 can be part of or can be formed with the first bracket 232. In some examples, the bracket 278 can be connected to the first bracket 232. The lock assembly 275 can also include a plate 280 that, together with the bracket 278, can at least partially surround moving components of the lock assembly 275. The lock assembly 275 can also include a hinge bolt 282 and a lock bolt 284. The hinge bolt 282 can be a pin, bolt, fastener, or the like extending at least partially through the plate 280 and the bracket 278 and can be secured (e.g., threadably secured) to the movable portion 238. The hinge bolt 282 can, together with the hinge bolt 262, form a rotational axis for the movable portion 238 (e.g., along the rotational axis R). The hinge bolt 282 can also interface with a bearing similar to the bearing 264.

The lock assembly 275 can also include a lock pin 284 (or lock bolt) that can extend at least partially through the plate 280 and the bracket 278. The lock pin 284 can be a pin, bolt, fastener, or the like, and can extend at least partially through a slot 286 of the bracket 278 and can be connected to the movable portion 238. The slot 286 can be an elongate track, guide, or cam profile extending at least partially through the bracket 278 and configured to at least partially define a range of motion of the movable portion 238. The lock pin 284 can be movable with the movable portion 238 between the upright position and the lowered position and can be guided in travel by engagement between the lock pin 284 and the slot 286.

The lock assembly 275 can also include a primary hook 288 and a secondary latch 290 (shown in FIGS. 10 and 12). The primary hook 288 can be secured to the bracket 278 by a fastener 289, which can also define a rotational axis of the primary hook 288. Similarly, the secondary latch 290 can be secured to the bracket 278 by a fastener 291, which can also define a rotational axis of the secondary latch 290.

The primary hook 288 can include a hook or latch interface engageable with the lock pin 284, such as to secure the lock pin 284 and therefore the movable portion 238 in the upright configuration when the movable portion 238 is in the upright configuration and the primary hook 288 is moved to a latched position. The primary hook 288 can also be rotatable or movable to an unlatched position where the primary hook 288 can disengage the lock pin 284 allowing the lock pin 284 to move freely as guided by the slot 286, allowing the movable portion 238 to move to the lowered position or configuration. The lock assembly 275 can also include a primary biasing element 292 that can be engaged with the primary hook 288 and the bracket 278 or the plate 280. The primary biasing element 292 can be configured to bias the primary hook 288 to rotate toward the latched position. The primary biasing element 292 can be a torsion spring, or the like.

The secondary latch 290 can include an arm 293 that is engageable with a tang 294 of the primary hook 288. The lock assembly 275 can also include a secondary biasing element 295 that can be connected to the bracket 278 and can be engaged with a pin 296. The pin 296 can be movably engaged with the secondary latch 290 to bias the secondary latch 290 such that the arm 293 is biased towards engagement with the tang 294. The secondary biasing element 295 can be a torsion spring, or the like.

Also, the release 248 can include a cable 297 extending through a guide tube 298 and connected to a handle 299. The cable 297 can be connected to the handle 299 at one end and can be connected to the secondary latch 290 at an opposite end. The handle 299 can be exposed when the movable portion 238 is in the upright position. In such a position, the handle 299 can be operable to pull the handle 299 outward, such as away from the backrest portion 220a, causing the cable 297 to move and to apply a force on the secondary latch 290.

When the force applied on the cable 297 (from the handle 299) is sufficient to overcome a biasing force of the secondary biasing element 295, the cable 297 can cause the pin 296 to move or rotate and can engage the secondary latch 290 to cause the secondary latch 290 to rotate, which can clear a path for the tang 294. The cable 297 can also be connected to the primary hook 288 (directly or via the pin 296 or another component) such that the force of cable 297 can be transferred to the primary hook 288 and when the force exceeds a biasing force of the primary biasing element 292, the primary hook 288 can rotate to disengage the lock pin 284. When the lock pin 284 is disengaged by the primary hook 288, the lock pin 284 can be free to travel along the slot 286 as the hinge assembly 254 (or force from a user) moves the movable portion 238 toward the lowered position or configuration.

When the movable portion 238 is moved back from the lowered position toward the stored position, the lock pin 284 can travel from an upper portion of the slot 286 to enter the primary hook 288, where the primary hook 288 can be biased by the primary biasing element 292 to the locked position around the lock pin 284. When the primary hook 288 moves to this position, the secondary latch 290 can also be biased by the secondary biasing element 295 to rotate such that the arm 293 engages the tang 294 and further biases the primary hook 288 toward the locked position. Engagement between the arm 293 and the tang 294 can help maintain the primary hook 288 in the locked position and can take up any slack therebetween, such as to help limit rattling or movement of the primary hook 288, increasing safety and improving a quality of feel and sound. The lock assembly 275 can be repeatedly used to lock and unlock the movable portion 238 as desired.

When in the locked configuration, the primary hook 288 and the lock pin 284 can be configured (e.g., sized and shaped) to take or distribute a load from the seat belt when the occupant is moving the forward direction, such as during a crash or impact event. Though the seat assembly 200 is discussed above as being a rear seat assembly, the seat assembly 200 can be a front seat assembly or middle row seat assembly. Further, the features of the middle seat assembly 214 can be included in any driver seat assembly or passenger seat assembly.

The present disclosure can include a seat armrest module that integrates an armrest and headrest into a single assembly. In one or more examples, the armrest can function as a seatback when in a stowed (e.g., up) position and as an armrest when in a deployed (e.g., down) position. In addition, while the armrest is in the stowed position, user comfort and safety can be increased by extending the headrest out of the armrest and into an extended position. The disclosed module can help provide an advantage over conventional vehicle seat assemblies, particularly for rear, second or third row seats, as the conventional technology implements armrests and headrests via separate and independent sub-systems, leading to more steps during vehicle assembly.

In addition, the disclosed seat armrest module can be used as a “plug-and-play” module that can be replaced by other modules containing more, fewer and/or different features, without impacting surrounding geometry or assembly processes. For example, in one or more examples, the armrest can be provided with a cup holder that is exposed when the armrest is in the deployed position. In one or more examples, the armrest can provide additional features such as storage, wireless phone charging, USB ports and/or a control panel that are exposed when the armrest is in the deployed position. Due to the modularity of the disclosed module, these features may be implemented and or swapped out in a “plug and play” manner as desired by the manufacturer or as ordered by a customer.

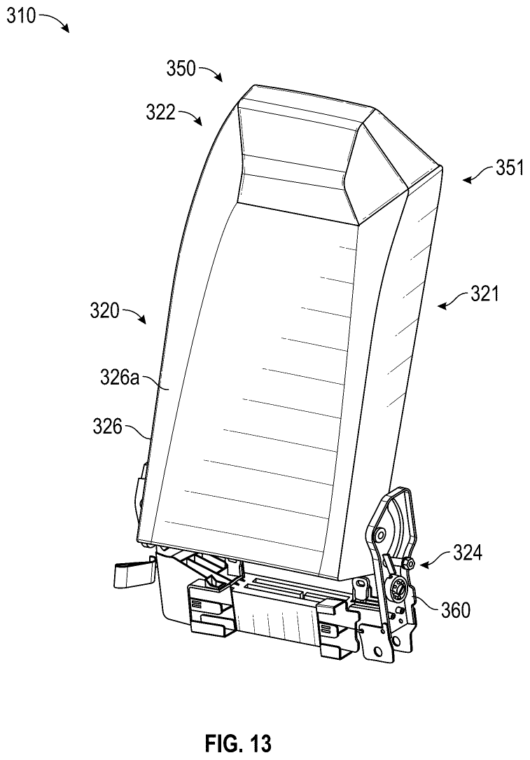

FIG. 13 illustrates a perspective view of a seat armrest module 310, according to some examples of the present disclosure. The illustrated module 310 can include an armrest 320 and a headrest 350 that can be inserted into the armrest 320 at top portion 322 of the armrest 320. The armrest 320 can include a body portion 326 attached to a mounting bracket 360 at a bottom portion 324 of the armrest 320. As shown in FIG. 13, the armrest 320 can be in a first or stowed position 321, whereby a front surface 326a of the body portion 326 can function as a seatback.

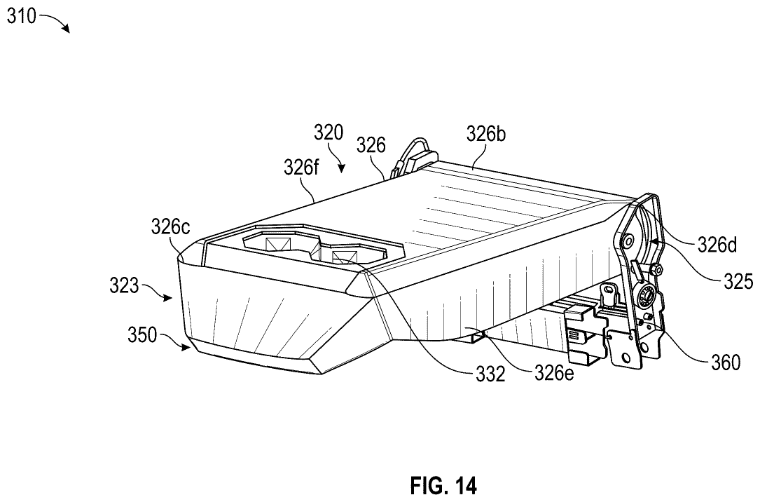

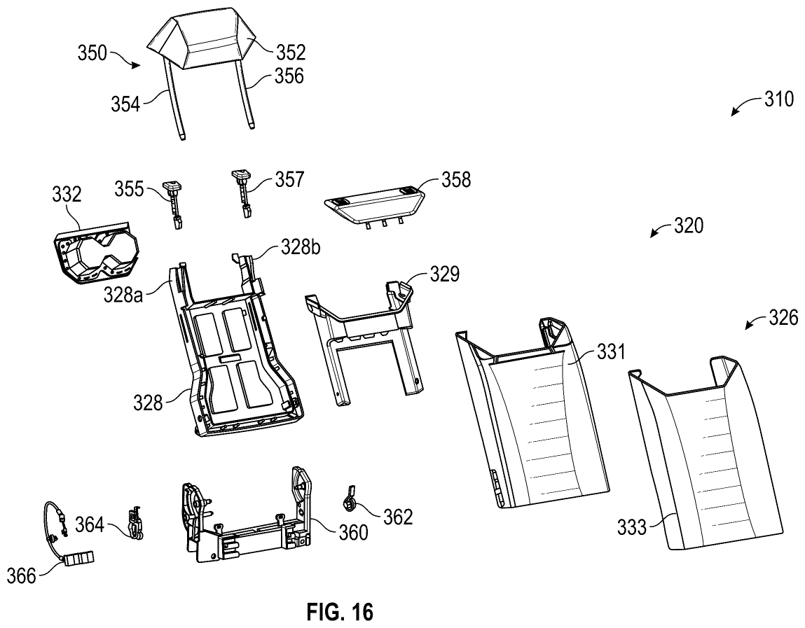

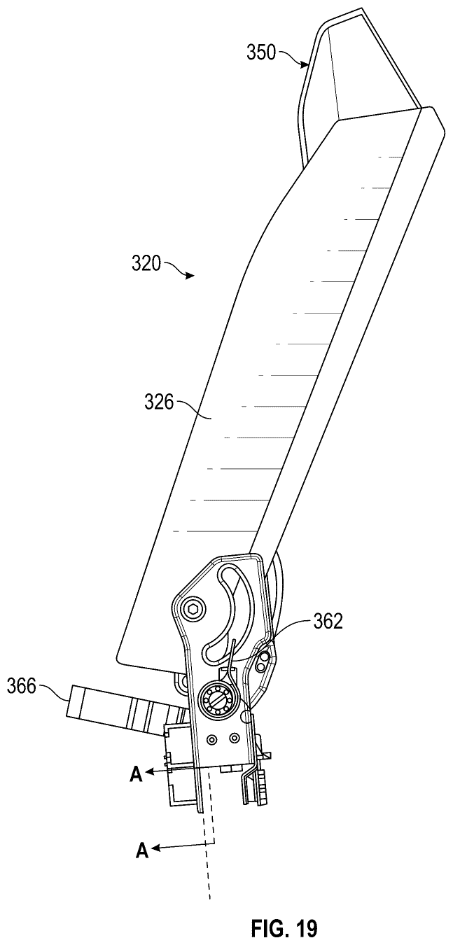

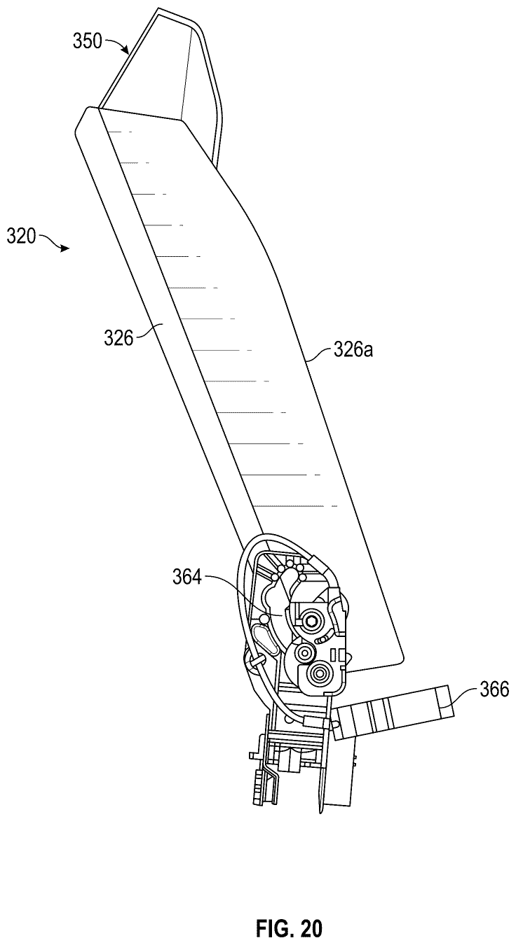

Turning to FIG. 14, the armrest 320 is shown in a second or deployed position 323, whereby a back surface 326b of the body portion 326 can function as an armrest. In the illustrated example, a cup holder 332 is attached to, or formed within, a top end 326c of the body portion 326. In the illustrated example, the armrest 320 can be moved into the deployed position 323 by rotating the body portion 326 about an axis 325 at or near a bottom end 326d of the body portion 326 (discussed in more detail below with respect to FIGS. 16-23).

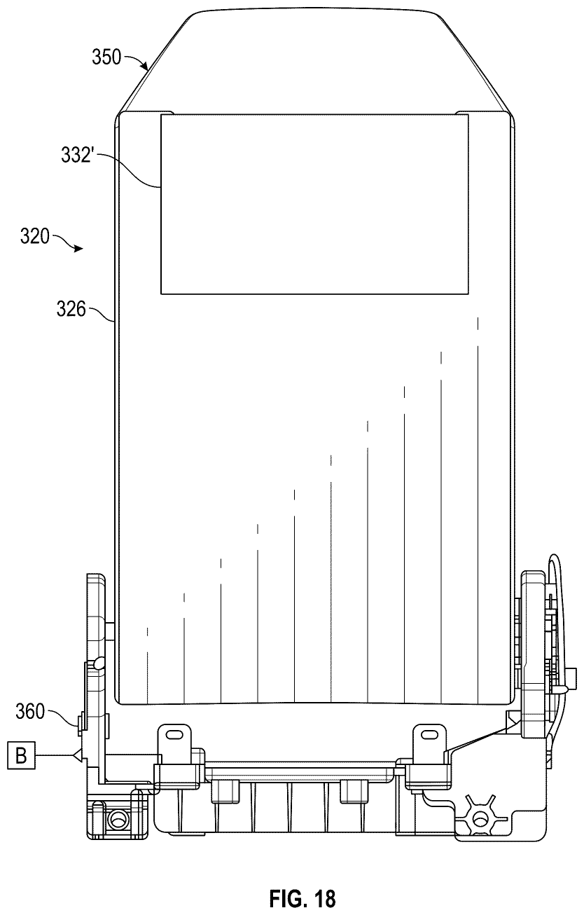

In the illustrated example, the armrest 320 can be provided with a cup holder 332 that can be exposed when the armrest 320 is in the deployed position 323. In one or more examples, the armrest 320 can include additional features such as a storage space, wireless phone charger, USB ports or a control panel (332 in FIG. 18) that can be exposed when the armrest is in the deployed position 323. Due to the modularity of the module 310, these features (e.g., cup holder, storage, wireless phone charger, USB ports or a control panel, etc.) can be implemented or swapped out in a “plug and play” manner as desired by the manufacturer or as ordered by a customer simply by selecting a module 310 with the desired feature or features.

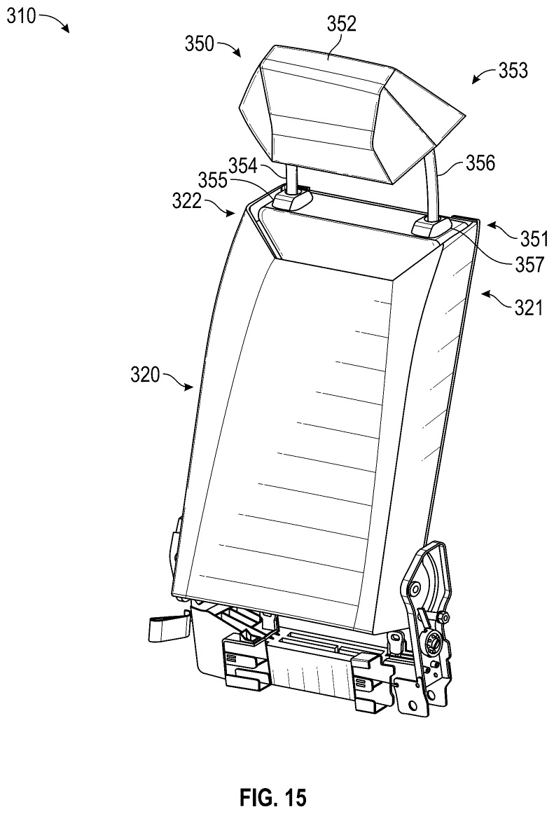

Turning now to FIG. 15, the headrest 350 is shown in a fully extended position 353 from its original non-extended position 351. The headrest 350 can include a body portion 352 connected to two guiderails 354, 356 that can be received in the top portion 322 of the armrest 320 via headrest guide clips 355, 357. The body portion 326 can include holes sized to receive the headrest guide clips 355, 357 and guiderails 354, 356 and long enough to accept at least a substantial length of the guiderails 354, 356 (discussed in more detail with respect to FIG. 12). In one or more examples, the distance the headrest 350 may be extended from the non-extended position 351 to extended position 353 can be dictated by length of the guide rails 354, 356.

In the illustrated example, the headrest guide clips 355, 357 can be attached to the top portion 322 of the armrest 320. The guiderails 354, 356 can be passed through the clips 355, 357 and into the armrest 320. In one or more examples, one or both of the clips 355, 357 can include an actuator (e.g., a depressible tab) that can be depressed to allow the guiderails 354, 356 to be extended out of the armrest 320 or re-inserted into the armrest 320. In one or more examples, the guiderails 354, 356 can include grooved portions that can engage with the actuators of the clips 355, 357 (i.e., when their actuators are not depressed) to form individual extended positions. In those examples, the clips' 355, 357 actuator can be depressed to allow the guiderails 354, 356 to be extended through each position defined by the grooved portions.

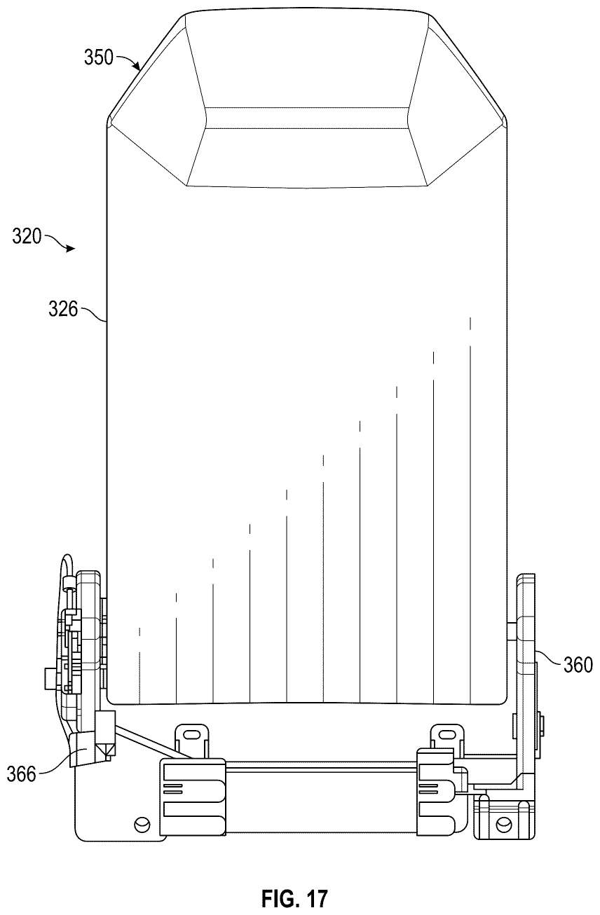

FIG. 16 is an exploded view of portions of the module 310 illustrated in FIGS. 13-15 providing some additional details of the components included therein. FIGS. 17-23 are additional views of the armrest 320 and headrest 350 of the module 310.

In the illustrated example, the body portion 326 of the armrest 320 can include an armrest frame 328, armrest substrate 329, armrest interior material 331, and armrest exterior material 333. In the illustrated example, the armrest frame 328 can be made from a magnesium alloy that is die cast into shape. However, in one or more examples, the frame 328 can be made from other suitable metals such as steel and aluminum. In one or more examples, the frame 328 may be made using injection molded plastic composites such as glass filled polypropylene. In the illustrated example, the substrate 329 can be made from an injection molded plastic composite with a 30% glass fiber filling and a copolymer matrix of polypropylene and polyethylene. In one or more examples, the substrate 329 can be made from most injection molded plastics that can provide sufficient structural rigidity. In the illustrated example, the armrest interior material 331 can be made of foam and the armrest exterior material 333 is one of fabric, leather, pseudo-leather, or any other material suitable for a vehicle seatback. In one example example, the armrest interior material 331 and armrest exterior material 333 can be provided over the armrest substrate 329 and the armrest frame 328. The armrest substrate can be attached to the armrest frame 328 by any suitable mechanism. It should be appreciated that the materials used for the body portion 326 components are exemplary and that other materials suitable for a vehicle implementation may be used.

In one or more examples, an armrest top cap 358 can be attached to the top of the body portion 326. The headrest guide clips 355, 357 can also be provided through the armrest top cap 358 and body portion 326 and received by corresponding openings 328a, 328b in the frame 328.

The mounting bracket 360 can be configured to be received by a portion of a seat bottom or other assembly in a vehicle seat or row of seats. In certain examples, the mounting bracket 360 can include or be attached to a spring assembly 362, latch 364 and release strap 366. The spring assembly 362, latch 364 and release strap 366 can form a locking mechanism, which can be located at a low point of the module 310 (near its pivot) to limit a need for visible latches or expensive magnet executions. In the illustrated example, the locking mechanism can be unlocked using the pull strap 366. It should be appreciated, however, that the locking mechanism can be modified to use a mechanical or electrical actuator such that user input can be through a button or a touch screen input at any desired location of the module 310 or a control panel of the vehicle. In addition, the locking mechanism can be replaced with a locking recliner. It should also be appreciated that the locking mechanism components can be located higher up on the module 310, which can provide a more robust locking system if desired.

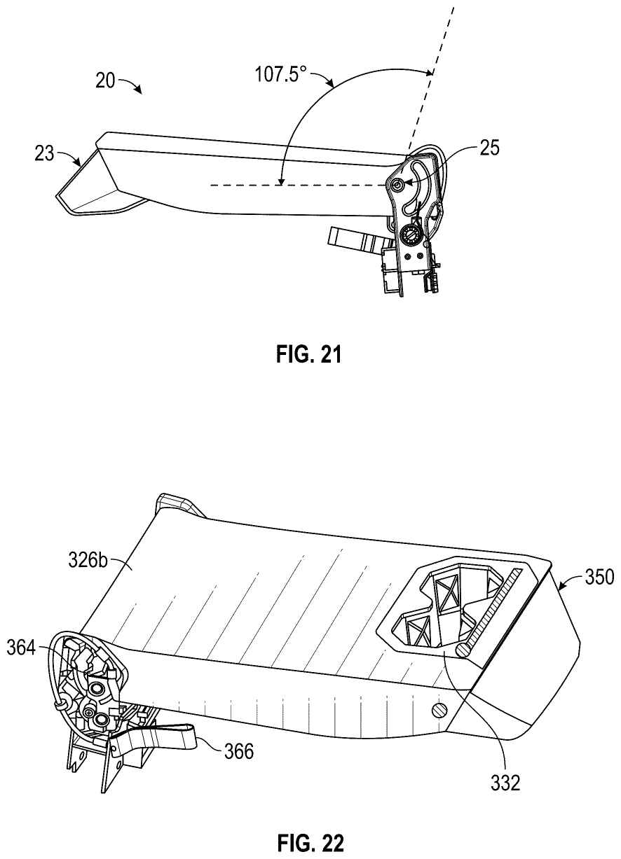

FIGS. 21 and 22 show the armrest 320 in the deployed position 323. In the illustrated example, the armrest 320 can have approximately 107.5 degrees of motion and can be pivoted about the axis 325. In one or more examples, different armrest positions can be provided between the stowed 321 and deployed 23 positions. The additional positions can be provided by the latch 364 or a ratchet type mechanism used in the locking mechanism as one example. It should be appreciated that the disclosed module 310 should not be limited to the amount or degree of movement of the armrest 320.

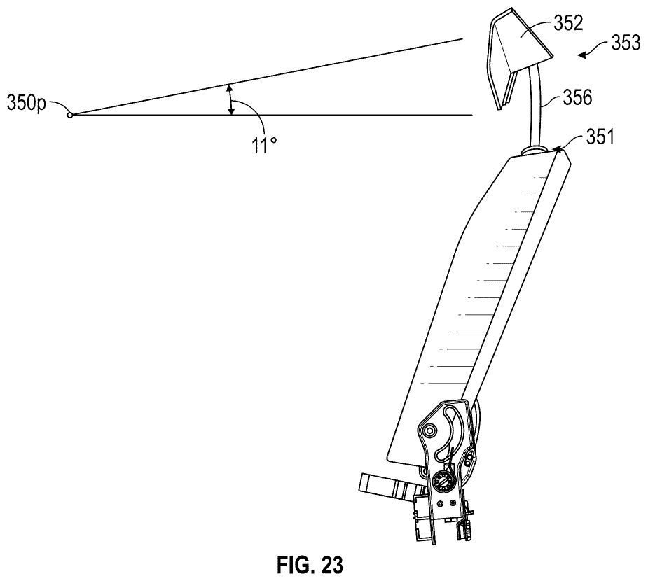

FIG. 23 shows the headrest 350 in its fully extended position 353. In the illustrated example, the headrest 350 also can have approximately 11 degrees of motion with respect to an example pivot axis 350p. The headrest 350 can be extended any length between the original 351 and extended 353 positions. It should be appreciated that the disclosed module 310 should not be limited to the amount or degree of rotation or movement of the headrest 350.

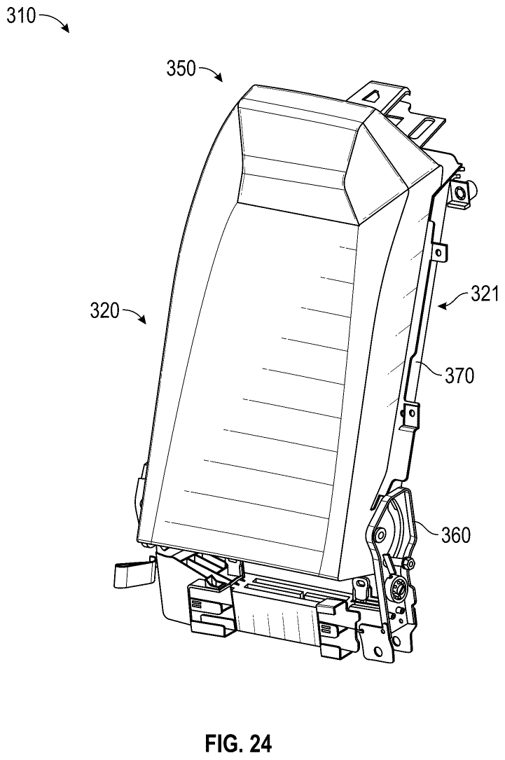

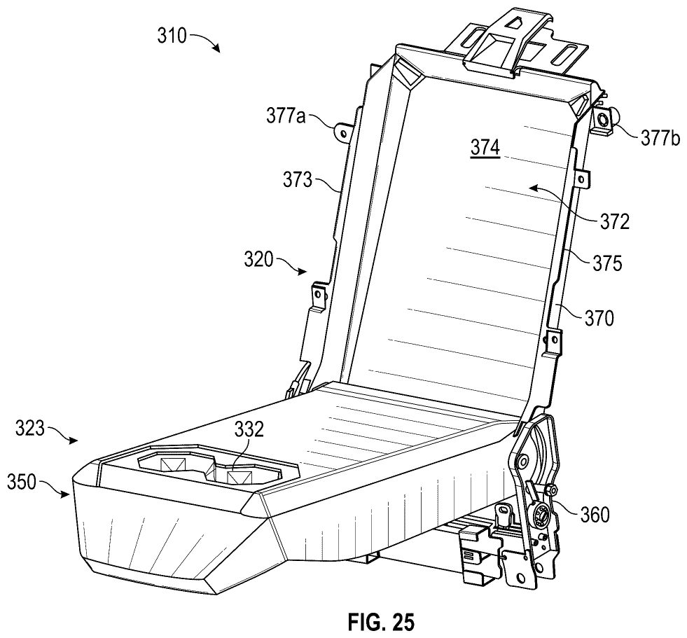

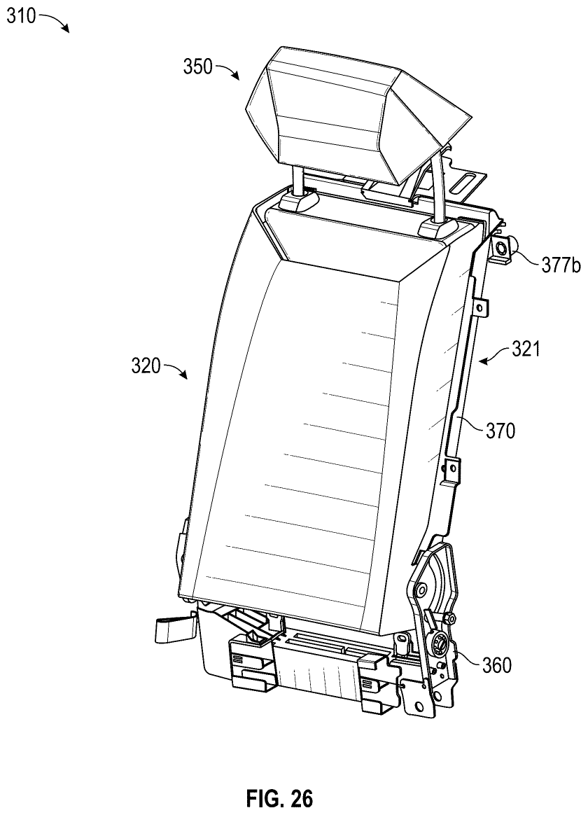

FIGS. 24-27 show the module 310 used with a seat interface frame 370 (sometimes referred to as a closeout assembly). In one or more examples, the frame 370 can include a backing 374 formed between two sides 373, 375. In one or more examples, the backing 374 can be removed, leaving an open area between the sides 373, 375 in the back of the frame 370 and module 310. This open area can provide a mechanism to pass an object through the module 310, such as an object (e.g., surfboard, fishing poles, large packages, or other elongated objects) in a rear or trunk space of the vehicle, when the armrest 320 is in the deployed position 323.

The illustrated example includes mounting features 377a, 377b, allowing the seat interface frame 370 and the module 310 to be installed in a vehicle. The mounting features 377a, 377b (for example) are shown as holes configured to allow a bolt or screw to pass therethrough and into a corresponding structure in the vehicle. It should be appreciated, however, that any other suitable mounting feature can be incorporated into the frame 370 and that the disclosed principles are not limited to the example features 377a, 377b of the illustrated example.

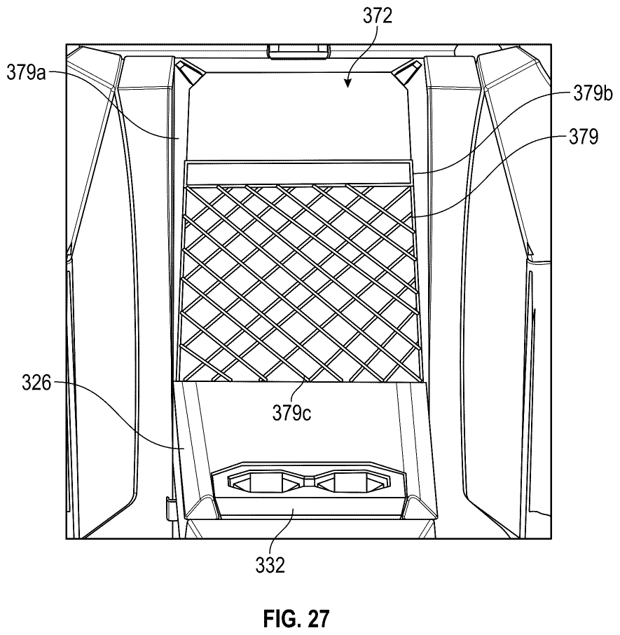

In one or more examples, a cavity 372 can be formed within the seat interface frame 370. The cavity 372 can be configured to accept at least the back surface 326b and at least portions of side surfaces 326e, 326f of the body portion 326. In one or more examples, as shown in FIG. 27, the cavity 372 can be large enough to also have room for additional storage, which can include a storage net 379 or other holding mechanism to maintain items within the storage space. The net 379 can be attached to the frame 370 at various connection points 379a, 379b, 379c by any suitable mechanism.

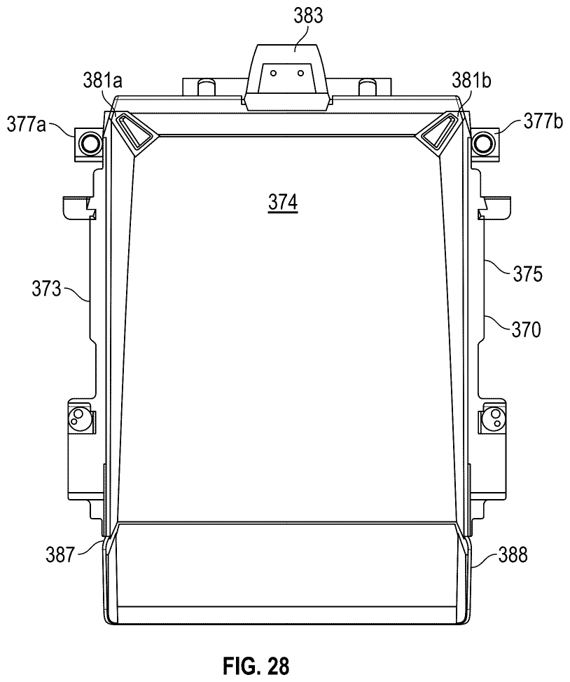

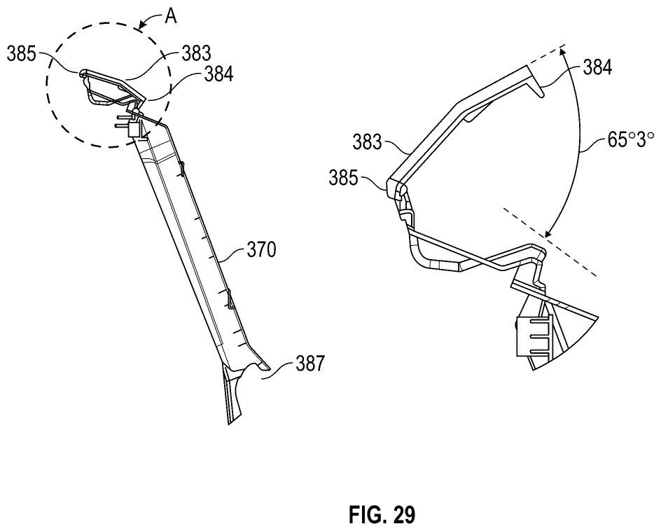

As shown in more detail in FIGS. 28 and 29, the seat interface frame 370 can include bumpers 377a, 377b and a tether cap 383. Each of these components can be made of plastic, rubber or any other suitable material. The tether cap 383 can be used to accept a strap or other mechanism from a child seat (or pet restraining mechanism or leash). As shown in the insert of FIG. 29, in one or more examples, a front end 384 of the tether cap 383 can be openable and the cap 383 can be rotatable at a point 385 to assist in receiving the strap or other mechanism. Slots 387 and 388 can provided in the seat interface frame 370 so that the frame can be installed as part of the module 310 on both sides of the mounting bracket 360 (e.g., in between the armrest body portion 326 and the bracket 360).

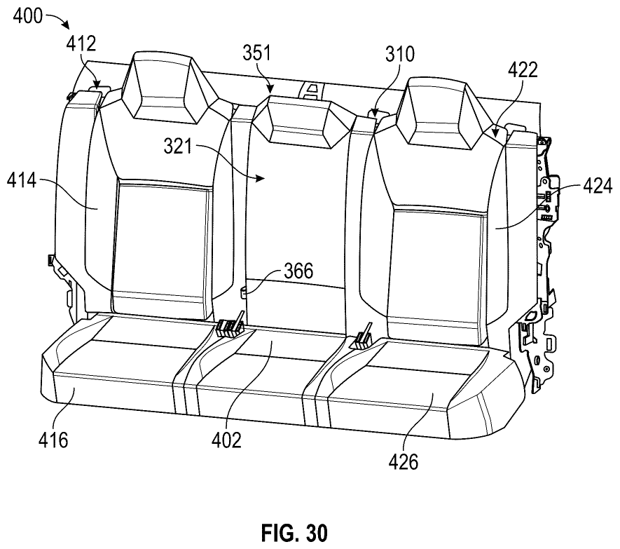

FIGS. 30 to 32 illustrate the example module 310 and seat interface frame 370 installed between two outboard seats 412 and 422 forming a seat row 400 according to some examples of the present disclosure. In certain examples, the row 400 can form a rear seat of the vehicle. In certain examples, the row 400 can form a second and or third row of seats in a larger vehicle.

In the illustrated example, the first seat 412 can include a first seatback portion 414 and a first seating area portion 416 and the second seat 422 can include a second seatback portion 424 and a second seating area portion 426. As shown, the module 310 has been inserted in between the two outboard seats 412, 414 and together with a seating portion 402 forms a center seat of the row 400. It should be appreciated, however, that the disclosed principles are not limited to where the module 310 is inserted and the module 310 can be used to form any seat (outboard, center, standalone) in any row (front, rear, second or third, etc.) of the vehicle.

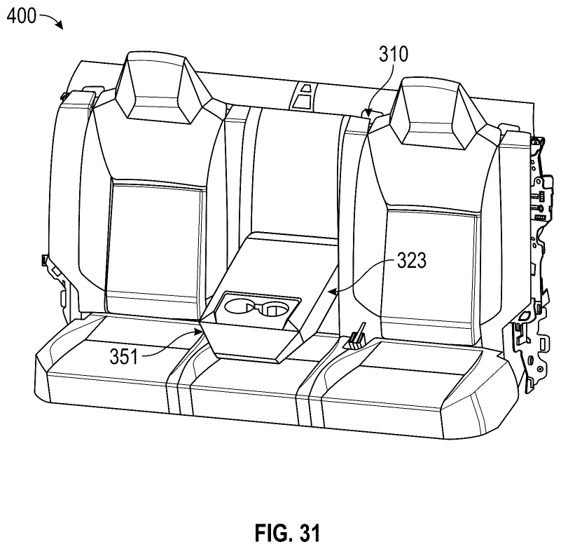

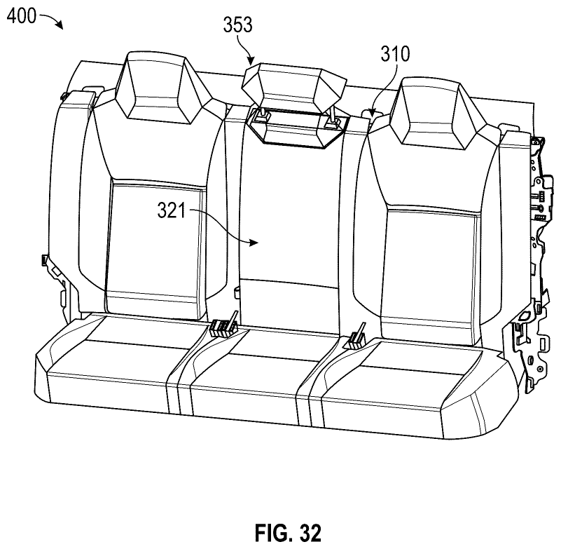

FIG. 30 shows the armrest of the module 310 in its first position 321 and the headrest in its non-extended position 351. FIG. 31 shows the armrest of the module 310 in its second position 323 and the headrest in its non-extended position 351. FIG. 32 shows the armrest of the module 310 in its first position 321 and the headrest in its extended position 353.

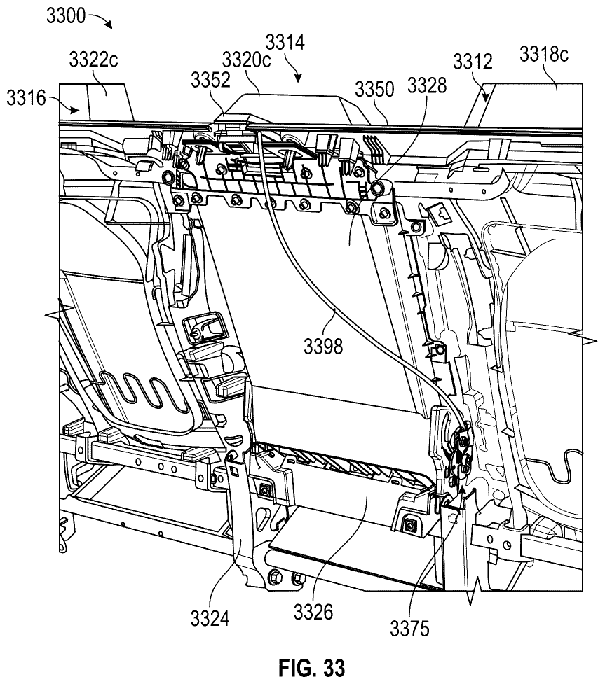

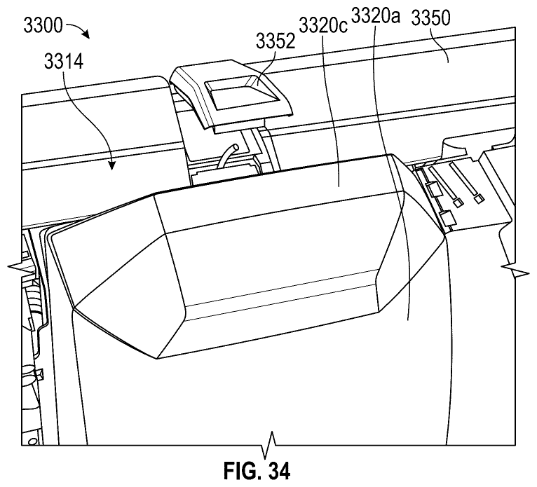

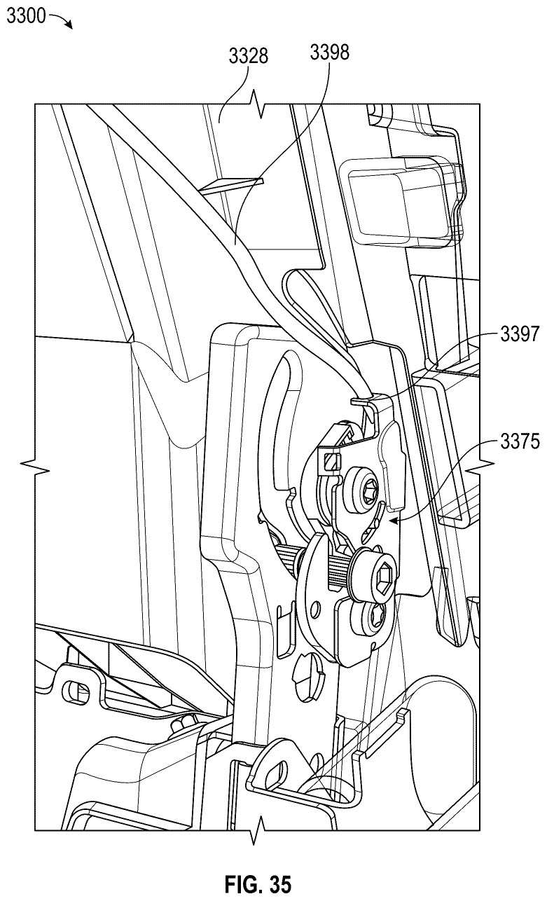

FIG. 33 illustrates an isometric view of a portion of a seat assembly 3300, according to some examples. FIG. 34 illustrates an isometric view of a portion of the seat assembly 3300, according to some examples. FIG. 35 illustrates an isometric view of a portion of the seat assembly 3300, according to some examples. FIGS. 33-35 are discussed together below. The seat assembly 3300 can be similar to the seat assemblies discussed above, such as the seat assembly 200. Any of the seat assemblies above or below can include the features of the seat assembly 3300.

The seat assembly 3300 can a passenger seat 3312, a middle seat 3314, and a driver seat 3316, which can be similarly configured to the passenger seat 212, the middle seat 214, and the driver seat 216, respectively. FIGS. 33 and 34 also show that the seat assembly 3300 can include an upper panel 3350 located near a top portion of the backrest portions (e.g., the backrest portion 3320a). The upper panel 3350 can be connected to one or more structural members 3324, a cross-member 3326 (which can be similar to the one or more structural members 224 and the cross-member 226, respectively), or a backing 3328. The upper panel 3350 can be configured to cover one or more frame member, wire, or the like.

The seat assembly 3300 can also include a latch 3352 connected to the upper panel 3350, such as behind a headrest portion 3320c. The latch 3352 can be a mechanical latch, switch, handle, catch, release, or the like that can be user operable to move a lock assembly 3375 (which can be similar to the lock assembly 275) from a locked configuration to an unlocked configuration to allow the backrest portion 3320a to be moved from the upright or stored configuration to the deployed or armrest configuration. For example, the latch 3352 can be connected to the lock assembly 3375 via a cable 3397 and a guide tube 3398 (which can be similar to the cable 297 and the guide tube 298, respectively).

In operation of some examples, as shown in FIG. 34, the latch 3352 can be operated or moved to an extended position to actuate or operate the cable 3397 to move the lock assembly 3375 to the unlocked position to allow the backrest portion 3320a to be moved from the upright or stored configuration to the deployed or armrest configuration. The seat assembly 3300 can thereby provide a release mechanism that is easy to locate and operate and allows for quick and simple movement of the backrest portion 3320a from the upright or stored position to the lowered position.

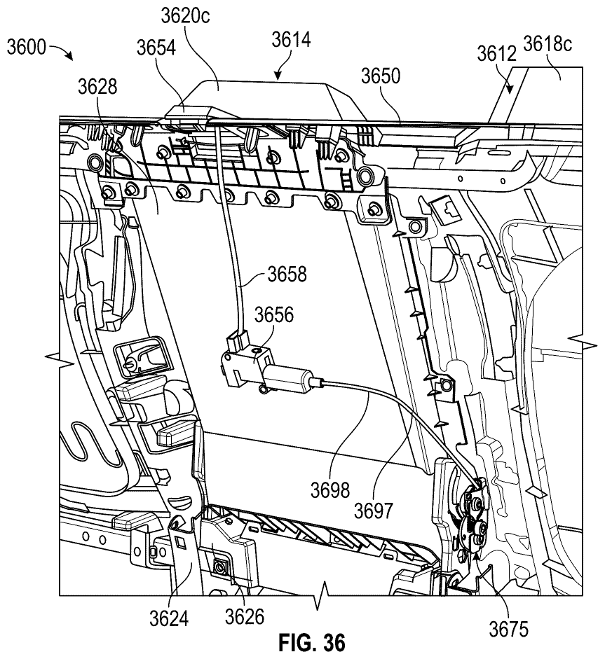

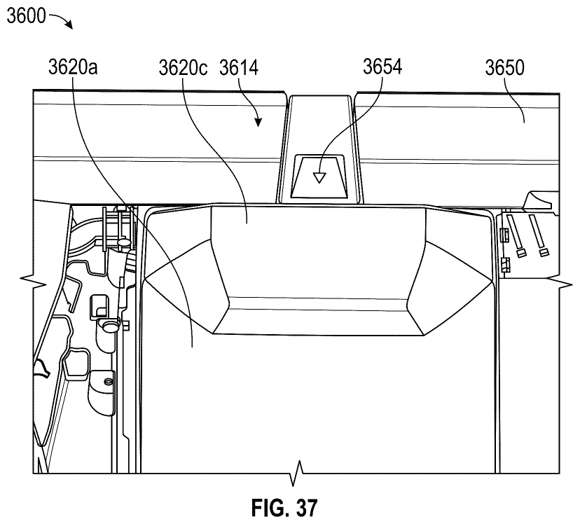

FIG. 36 illustrates an isometric view of a portion of a seat assembly 3600, according to some examples. FIG. 37 illustrates an isometric view of a portion of a seat assembly 3600, according to some examples. FIGS. 36 and 37 are discussed together below. The seat assembly 3600 can be similar to the seat assemblies discussed above, such as the seat assembly 200 and the seat assembly 3300. Any of the seat assemblies above or below can include the features of the seat assembly 3600.

The seat assembly 3600 can a passenger seat 3612, a middle seat 3614, and a driver seat 3616, which can be similarly configured to the passenger seat 212, the middle seat 214, and the driver seat 216, respectively. FIGS. 36 and 37 show that the seat assembly 3600 can include an upper panel 3+50 located near a top portion of the backrest portions (e.g., the backrest portion 3620a). The upper panel 3650 can be connected to one or more structural members 3624, a cross-member 3626 (which can be similar to the one or more structural members 224 and the cross-member 226, respectively), or a backing 3328. The upper panel 3650 can be configured to cover one or more frame member, wire, or the like.

The seat assembly 3600 can also include a switch 3654 that can be connected to the upper panel 3650 such as located behind or to a rear of a headrest portion 3620c. The switch 3654 can be an electric or electro-mechanical button, switch, sensor, or the like that can be user-operable, such as user-pressable or user-depressible to generate a signal. The seat assembly 3600 can also include an actuator 3656 connected to a cover 3628. The actuator 3656 can be connected to the seat assembly 3600 in in other locations. The actuator 3656 can be a motor, actuator, or the like configured to translate, rotate, or otherwise move in response to receiving a signal. The actuator 3656 can be connected to a lock assembly 3675 via a cable 3697 and a guide tube 3698 (which can be similar to the cable 297 and the guide tube 298, respectively).

In operation of some examples, the switch 3654 can be operated (e.g., by a user) by pressing the switch 3654 to send a signal to the 3656 via a wired connection 3658 (or a wireless connection, such as Bluetooth™, NFC, or the like). In response to the signal, the actuator 3656 can operate the cable 3697, such as by pulling on the cable 3697, to cause the cable 3697 to operate the lock assembly 3675 to move to the unlocked position to allow the backrest portion 3620a to be moved from the upright or stored configuration to the deployed or armrest configuration. The seat assembly 3600 can thereby provide a release mechanism that is easy to locate and operate and allows for quick and simple movement of the backrest portion 3620a from the upright or stored position to the lowered position.

### NOTES AND EXAMPLES

The following, non-limiting examples, detail certain aspects of the present subject matter to solve the challenges and provide the benefits discussed herein, among others.

Example 1 can include a seat module for an automotive vehicle, the seat module comprising: a frame securable to a chassis of the automotive vehicle; a driver seat connected to the frame and a passenger seat connected to the frame; and a middle seat assembly located between the driver seat and the passenger seat, the middle seat assembly including: a middle frame securable to the frame; a fixed portion connected to the middle frame; and a movable portion including a headrest, the movable portion pivotably connected to the middle frame and movable between an upright position where the movable portion forms a backrest of a middle seat and between a lowered position where the movable portion forms an armrest.

In Example 2, the subject matter of Example 1 can include a hinge connected to the movable portion and connected to the middle frame, the hinge configured to allow the movable portion to pivot between the upright position and the lowered position.

In Example 3, the subject matter of Example 2 can include wherein the hinge includes: a body connected to the middle frame, the body defining a track; and a guide secured to the movable portion and extending through the track, the guide engageable with the track to guide movement of the movable portion between the upright position and the lowered position.

In Example 4, the subject matter of Example 3 can include a biasing element connected to the body and engaged with the guide, the biasing element configured to bias the guide and the movable portion toward the lowered position.

In Example 5, the subject matter of any one or more of Examples 3-4 can include a hinge pin extending through the body and connected to the movable portion, the hinge pin defining a rotational axis of the movable portion between the upright position and the lowered position.

In Example 6, the subject matter of any one or more of Examples 4-5 can include a stop connected the body, the biasing element engageable with the stop to limit a range of engagement between the biasing element and the guide.

In Example 7, the subject matter of any one or more of Examples 1-6 can include a lock connected to the middle frame and movable between a locked configuration and an unlocked configuration, the lock configured to retain the movable portion in the upright position when in the locked configuration, and the lock configured to release the movable portion when in the unlocked configuration.

In Example 8, the subject matter of Example 7 can include wherein the lock comprises: a lock bracket connected to the middle frame; a primary lock pin extending at least partially through the lock bracket and connected to the movable portion; and a primary hook connected to the lock bracket and movable between a latched position where the primary hook engages the primary lock pin and movable between an unlatched position where the primary hook releases the primary lock pin.

In Example 9, the subject matter of Example 8 can include wherein the lock comprises: a secondary latch engageable with the primary hook to bias the primary hook towards the latched position.

In Example 10, the subject matter of Example 9 can include wherein the lock comprises: a primary biasing element engaged with the primary hook and configured to bias the primary hook toward the latched position; and a secondary biasing element engaged with the secondary latch and configured to bias the secondary latch toward engagement with the primary hook.

In Example 11, the subject matter of Example 10 can include a release connected to the lock and configured to be exposed when the movable portion is in the upright position, the release operable to move the lock from the locked configuration to the unlocked configuration when a combined force of the primary biasing element and the secondary biasing element are overcome.

In Example 12, the subject matter of any one or more of Examples 7-11 can include a release connected to the lock and configured to be exposed when the movable portion is in the upright position, the release operable to move the lock from the locked configuration to the unlocked configuration.

In Example 13, the subject matter of any one or more of Examples 1-12 can include wherein the fixed portion includes a recess, the fixed portion configured to nest within the recess when the fixed portion is in the upright position.

Example 14 can include a middle seat assembly for an automotive vehicle, the middle seat assembly comprising: a middle frame securable to a frame of a seat assembly between a first seat and a second seat of the seat assembly; a fixed portion connected to the middle frame; and a movable portion including a headrest, the movable portion pivotably connected to the middle frame and movable between an upright position where the movable portion forms a backrest of a middle seat of the seat assembly and between a lowered position where the movable portion forms an armrest between the first seat and the second seat.

In Example 15, the subject matter of Example 14 can include a hinge connected to the movable portion and connected to the middle frame, the hinge configured to allow the movable portion to pivot between the upright position and the lowered position.

In Example 16, the subject matter of Example 15 can include wherein the hinge includes: a body connected to the middle frame, the body defining a track; and a guide secured to the movable portion and extending through the track, the guide engageable with the track to guide movement of the movable portion between the upright position and the lowered position.

In Example 17, the subject matter of Example 16 can include a biasing element connected to the body and engaged with the guide, the biasing element configured to bias the guide and the movable portion toward the lowered position.

In Example 18, the subject matter of any one or more of Examples 14-17 can include a lock connected to the middle frame and movable between a locked configuration and an unlocked configuration, the lock configured to retain the movable portion in the upright position when in the locked configuration, and the lock configured to release the movable portion when in the unlocked configuration.

In Example 19, the subject matter of Example 18 can include wherein the lock comprises: a lock bracket connected to the middle frame; a primary lock pin extending at least partially through the lock bracket and connected to the movable portion; and a primary hook connected to the lock bracket and movable between a latched position where the primary hook engages the primary lock pin and movable between an unlatched position where the primary hook releases the primary lock pin.

In Example 20, the subject matter of Example 19 can include wherein the lock comprises: a secondary latch engageable with the primary hook to bias the primary hook towards the latched position; a primary biasing element engaged with the primary hook and configured to bias the primary hook toward the latched position; and a secondary biasing element engaged with the secondary latch and configured to bias the secondary latch toward engagement with the primary hook.

Example 21 is a seat module for a vehicle, said module comprising: an armrest configured to rotate about a first axis at a first end of the armrest and between a first position and a second position; and a headrest configured to be received by and extendable from a second end of the armrest.

In Example 22, the subject matter of Example 21 can include wherein the first position is a seatback position and the second position is an armrest position.

In Example 23, the subject matter of any one or more of Examples 21-22 can include the armrest comprising: a body portion; and a cup holder formed within the body portion at the second end of the armrest and configured to be exposed when the armrest is in the second position.

In Example 24, the subject matter of any one or more of Examples 21-23 can include the armrest comprising: a body portion; and a phone charger formed within the body portion at the second end of the armrest and configured to be exposed when the armrest is in the second position.

In Example 25, the subject matter of any one or more of Examples 21-24 can include the armrest comprising: a body portion; and a USB port formed within the body portion at the second end of the armrest and configured to be exposed when the armrest is in the second position.

In Example 26, the subject matter of any one or more of Examples 21-25 can include the armrest comprising: a body portion; and a control panel formed within the body portion at the second end of the armrest and configured to be exposed when the armrest is in the second position.

In Example 27, the subject matter of any one or more of Examples 21-26 can include a mounting bracket located at a bottom portion of the armrest and configured to be received by a seat structure of the vehicle.

In Example 28, the subject matter of Example 27 can include a locking mechanism formed within the mounting bracket, the locking mechanism preventing the armrest from moving from the first position to the second position until the locking mechanism is unlocked.

In Example 29, the subject matter of any one or more of Examples 21-28 can include wherein: the headrest comprises a headrest body attached to a guide mechanism, the second end of the armrest comprises at least one opening for receiving the guide mechanism, and the headrest body and guide mechanism being extendable from the at least one opening.

In Example 30, the subject matter of Example 29 can include wherein the guide mechanism comprises two guiderails and the second end of the armrest comprises two openings, each opening receiving a respective one of the two guiderails.

Example 31 is an armrest for a vehicle seat, said armrest comprising: a body portion configured to rotate about a first axis at a first end of the body portion and between a first position and a second position; and a headrest configured to be received by and extendable from a second end of the body portion.

In Example 32, the subject matter of Example 31 can include wherein the first position is a seatback position and the second position is an armrest position.

In Example 33, the subject matter of any one or more of Examples 31-32 can include a cup holder formed within the body portion at the second end of the body portion and configured to be exposed when the body portion is in the second position.

In Example 34, the subject matter of any one or more of Examples 31-33 can include a phone charger formed within the body portion at the second end of the armrest and configured to be exposed when the body portion is in the second position.

In Example 35, the subject matter of any one or more of Examples 31-34 can include a USB port formed within the body portion at the second end of the armrest and configured to be exposed when the body portion is in the second position.

In Example 36, the subject matter of any one or more of Examples 31-35 can include a control panel formed within the body portion at the second end of the armrest and configured to be exposed when the body portion is in the second position.

In Example 37, the subject matter of any one or more of Examples 31-36 can include a mounting bracket located at a bottom portion of the body portion and configured to be received by a seat structure of the vehicle.

In Example 38, the subject matter of Example 37 can include a locking mechanism formed within the mounting bracket, the locking mechanism preventing the body portion from moving from the first position to the second position until the locking mechanism is unlocked.

In Example 39, the subject matter of any one or more of Examples 31-38 can include wherein: the headrest comprises a headrest body attached to a guide mechanism; and the second end of the body portion comprises at least one opening for receiving the guide mechanism.

In Example 40, the subject matter of Example 39 can include wherein the guide mechanism comprises two guiderails and the second end of the body portion comprises two openings, each opening receiving a respective one of the two guiderails.

In Example 41, the apparatuses or method of any one or any combination of Examples 1-40 can be configured such that all elements or options recited are available to use or select from.

The above detailed description includes references to the accompanying drawings, which form a part of the detailed description. The drawings show, by way of illustration, specific embodiments or examples in which the invention can be practiced. These examples are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other examples can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or embodiments, with each claim standing on its own as a separate embodiment, and it is contemplated that such embodiments can be combined with each other in various combinations or permutations. The scope of the inventive subject matter should be determined with reference to the appended claims, along with the full scope of equivalents to which such claims are entitled.

1. A seat module for an automotive vehicle, the seat module comprising:
a frame securable to a chassis of the automotive vehicle;
a driver seat connected to the frame and a passenger seat connected to the frame; and
a middle seat assembly located between the driver seat and the passenger seat, the middle seat assembly including:
a middle frame securable to the frame;
a fixed portion connected to the middle frame; and
a movable portion including a headrest, the movable portion pivotably connected to the middle frame and movable between an upright position where the movable portion forms a backrest of a middle seat and between a lowered position where the movable portion forms an armrest.

2. The seat module of claim 1, comprising:
a hinge connected to the movable portion and connected to the middle frame, the hinge configured to allow the movable portion to pivot between the upright position and the lowered position.

3. The seat module of claim 2, wherein the hinge includes:
a body connected to the middle frame, the body defining a track; and
a guide secured to the movable portion and extending through the track, the guide engageable with the track to guide movement of the movable portion between the upright position and the lowered position.

4. The seat module of claim 3, comprising:
a biasing element connected to the body and engaged with the guide, the biasing element configured to bias the guide and the movable portion toward the lowered position.

5. The seat module of claim 3, comprising:
a hinge pin extending through the body and connected to the movable portion, the hinge pin defining a rotational axis of the movable portion between the upright position and the lowered position.

6. The seat module of claim 4, comprising:
a stop connected the body, the biasing element engageable with the stop to limit a range of engagement between the biasing element and the guide.

7. The seat module of claim 1, comprising:
a lock connected to the middle frame and movable between a locked configuration and an unlocked configuration, the lock configured to retain the movable portion in the upright position when in the locked configuration, and the lock configured to release the movable portion when in the unlocked configuration.

8. The seat module of claim 7, wherein the lock comprises:
a lock bracket connected to the middle frame;
a primary lock pin extending at least partially through the lock bracket and connected to the movable portion; and
a primary hook connected to the lock bracket and movable between a latched position where the primary hook engages the primary lock pin and movable between an unlatched position where the primary hook releases the primary lock pin.

9. The seat module of claim 8, wherein the lock comprises:
a secondary latch engageable with the primary hook to bias the primary hook towards the latched position.

10. The seat module of claim 9, wherein the lock comprises:
a primary biasing element engaged with the primary hook and configured to bias the primary hook toward the latched position; and
a secondary biasing element engaged with the secondary latch and configured to bias the secondary latch toward engagement with the primary hook.

11. The seat module of claim 10, comprising:
a release connected to the lock and configured to be exposed when the movable portion is in the upright position, the release operable to move the lock from the locked configuration to the unlocked configuration when a combined force of the primary biasing element and the secondary biasing element are overcome.

12. The seat module of claim 7, comprising:
a release connected to the lock and configured to be exposed when the movable portion is in the upright position, the release operable to move the lock from the locked configuration to the unlocked configuration.

13. The seat module of claim 1, wherein the fixed portion includes a recess, the fixed portion configured to nest within the recess when the fixed portion is in the upright position.

14. A middle seat assembly for an automotive vehicle, the middle seat assembly comprising:
a middle frame securable to a frame of a seat assembly between a first seat and a second seat of the seat assembly;
a fixed portion connected to the middle frame; and
a movable portion including a headrest, the movable portion pivotably connected to the middle frame and movable between an upright position where the movable portion forms a backrest of a middle seat of the seat assembly and between a lowered position where the movable portion forms an armrest between the first seat and the second seat.

15. The middle seat assembly of claim 14, comprising:
a hinge connected to the movable portion and connected to the middle frame, the hinge configured to allow the movable portion to pivot between the upright position and the lowered position.

16. The middle seat assembly of claim 15, wherein the hinge includes:
a body connected to the middle frame, the body defining a track; and
a guide secured to the movable portion and extending through the track, the guide engageable with the track to guide movement of the movable portion between the upright position and the lowered position.

17. The middle seat assembly of claim 16, comprising:
a biasing element connected to the body and engaged with the guide, the biasing element configured to bias the guide and the movable portion toward the lowered position.

18. The middle seat assembly of claim 14, comprising:
a lock connected to the middle frame and movable between a locked configuration and an unlocked configuration, the lock configured to retain the movable portion in the upright position when in the locked configuration, and the lock configured to release the movable portion when in the unlocked configuration.

19. The middle seat assembly of claim 18, wherein the lock comprises:
a lock bracket connected to the middle frame;
a primary lock pin extending at least partially through the lock bracket and connected to the movable portion; and
a primary hook connected to the lock bracket and movable between a latched position where the primary hook engages the primary lock pin and movable between an unlatched position where the primary hook releases the primary lock pin.

20. The middle seat assembly of claim 19, wherein the lock comprises:
a secondary latch engageable with the primary hook to bias the primary hook towards the latched position;
a primary biasing element engaged with the primary hook and configured to bias the primary hook toward the latched position; and
a secondary biasing element engaged with the secondary latch and configured to bias the secondary latch toward engagement with the primary hook.
